(19) United States
(12) Patent Application Publication
(10) Pub. No.: US 2014/0067319 A1
(43) Pub. Date: Mar. 6, 2014

(54) MEASURING METHOD, NON-TRANSITORY COMPUTER READABLE RECORDING MEDIUM AND MEASURING APPARATUS

(71) Applicant: KABUSHIKI KAISHA TOSHIBA, Tokyo (JP)

(72) Inventor: Kenichiro OGURA, Yokkaichi-Shi (JP)

(73) Assignee: KABUSHIKI KAISHA TOSHIBA, Tokyo (JP)

(21) Appl. No.: 13/774,071

(22) Filed: Feb. 22, 2013

Related U.S. Application Data
(60) Provisional application No. 61/694,409, filed on Aug. 29, 2012.

(51) Int. Cl. G01B 11/24

(52) U.S. Cl. CPC G01B 11/24
USPC 702/167

(57) ABSTRACT

In accordance with an embodiment, a measuring method includes creating a sectional shape model for each measurement process of periodically arranged patterns formed through manufacturing processes, generating theoretical waveforms for a signal waveform which would be obtained when light is applied to the patterns, setting a shape parameter of a common structure in the manufacturing processes, acquiring measurement waveforms of the measurement target patterns, calculating degrees of correspondence between the measurement waveforms and theoretical waveforms, and outputting the shape parameter in the sectional shape model with the desired degree of correspondence. The calculating the degree of correspondence includes performing model fitting between the measurement waveforms and theoretical waveforms by varying the shape parameter of the common structure in the manufacturing processes and other shape parameters with the shape parameter of the common structure being linked.

### CROSS REFERENCE TO RELATED APPLICATIONS

This application is based upon and claims the benefit of U.S. provisional Application No. 61/694,409, filed on Aug. 29, 2012, the entire contents of which are incorporated herein by reference.

### FIELD

Embodiments described herein relate generally to a measuring method, a non-transitory computer readable recording medium and a measuring apparatus.

### BACKGROUND

A technique called scatterometry is known as a shape measuring method in a semiconductor device manufacturing process. According to this measuring method, light is applied to periodically arranged measurement target patterns, and a spectrum of the intensity of diffracted light is acquired. A spectrum of the intensity of the diffracted light which has been previously calculated from an estimated sectional shape is stored as a theoretical waveform in a database called a library. Model fitting of the theoretical waveform and the measurement waveform is then performed, and a sectional shape that matches the best is presented as a measurement result. This technique enables a nondestructive, high-throughput, and high-precision sectional measurement, and has recently been drawing special attention as a technique to measure sectional shapes such as the width and height of an interconnection.

### BRIEF DESCRIPTION OF THE DRAWINGS

In the accompanying drawings:

FIG. 1 is a block diagram showing a general configuration of a measuring apparatus according to an embodiment;

FIG. 2 is a block diagram showing a more detailed configuration of a control unit of the measuring apparatus shown in FIG. 1;

FIG. 3 is a sectional view showing an example of a measurement target pattern in a first measurement process;

FIG. 4 is a sectional view showing an example of a measurement target pattern in a second measurement process;

FIG. 5 is a sectional view showing a common structure of the measurement target patterns shown in FIG. 3 and FIG. 4;

FIG. 6 is a diagram illustrating a measurement by the measuring apparatus shown in FIG. 1;

FIG. 7 is a diagram illustrating a measuring method according to a referential example; and

FIG. 8 is a flowchart showing a general procedure of a measuring method according to one embodiment.

### DETAILED DESCRIPTION

In accordance with an embodiment, a measuring method includes generating a plurality of theoretical waveforms of periodically arranged patterns formed through a plurality of manufacturing processes, setting a first shape parameter, acquiring a plurality of measurement waveforms of a measurement target pattern obtained by actually creating the patterns in the respective measurement processes, calculating degrees of correspondence between the plurality of measurement waveforms and the plurality of theoretical waveforms, and outputting, as a measurement result of the measurement target pattern, the shape parameter in the sectional shape model with the desired degree of correspondence. The plurality of theoretical waveforms are generated by creating a sectional shape model for each measurement process for the patterns, and by predicting, by a simulation, a signal waveform which would be obtained when light is applied to the patterns. The plurality of measurement waveforms are acquired by applying light to the measurement target pattern and by measuring the intensity of a spectral waveform of reflected light. The degree of correspondence is calculated by performing model fitting between the plurality of measurement waveforms and the plurality of theoretical waveforms by varying the shape parameter of the common structure and other shape parameters with the shape parameter of the common structure in the manufacturing processes being linked. The shape parameter of the common structure and the other shape parameters in the sectional shape model with the highest degree of correspondence are output as a measurement result.

Embodiments will now be explained with reference to the accompanying drawings. Like components are provided with like reference signs throughout the drawings and repeated descriptions thereof are appropriately omitted. In addition, in the embodiment described below, a micropattern created in a semiconductor device manufacturing process such as a lithographic process or an etching process is measured. It should however be noted that the present invention is not at all limited thereto and is generally applicable to pattern evaluations in various industrial fields such as a liquid crystal panel manufacturing process.

### (1) One Embodiment of Measuring Apparatus

### (A) Apparatus Configuration

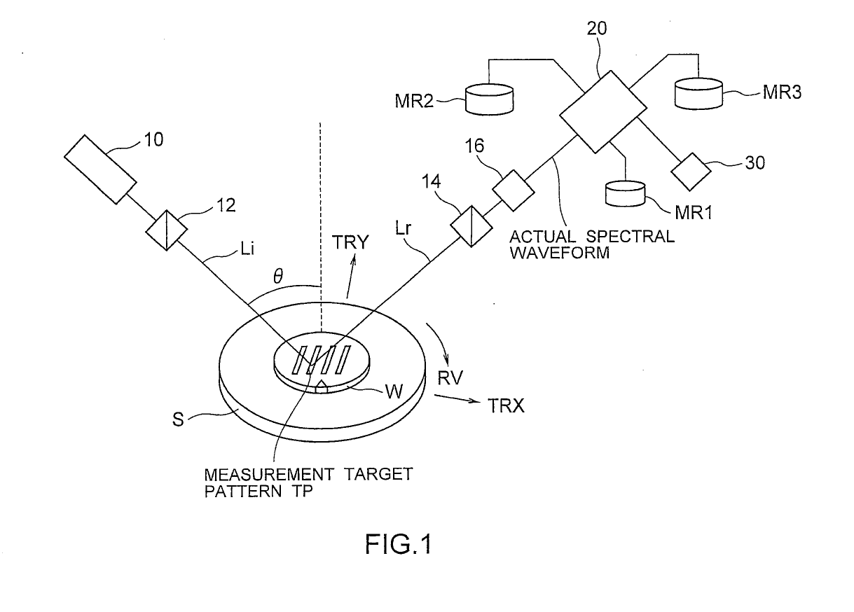

FIG. 1 is a block diagram showing a general configuration of a measuring apparatus according to the embodiment. The measuring apparatus shown in FIG. 1 includes an optical system according to a spectroscopic ellipsometer. The measuring apparatus includes a light source 10, a polarizer 12, a stage S, an analyzer 14, an array detector 16, a computer 20, an input unit 30, and recording devices MR1 to MR3.

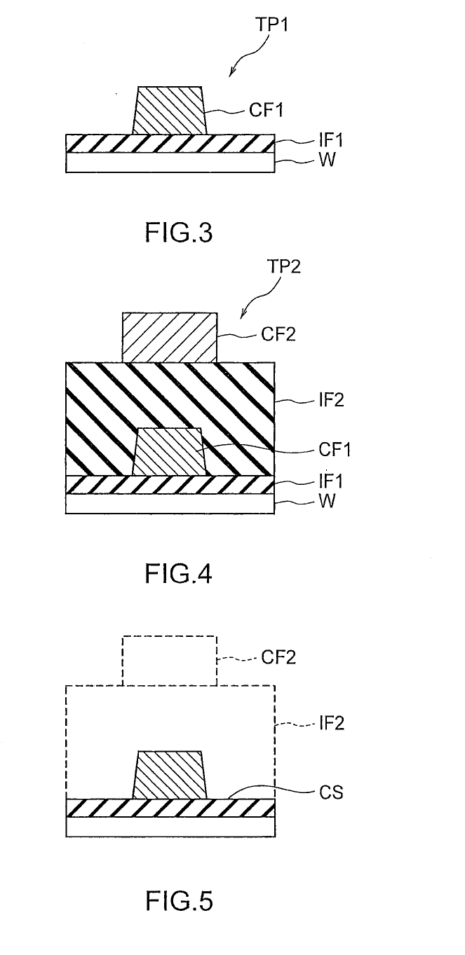

The light source 10 emits white light. The stage S moves a wafer W by rotary motion (RV direction) and translation motion (TRX direction, TRY direction). A pattern TP as a measurement target is formed on the surface of the wafer W by actually forming an intended pattern on the wafer W. As will be described later with reference to FIG. 3 and FIG. 4, a plurality of measurement processes are performed for a pattern manufactured through a plurality of processes according to a measurement in the present embodiment. It should be noted that the shape and structure of a measurement target pattern TP change every measurement.

The detector 16 includes a spectroscope, and outputs an actual spectral waveform of the pattern TR In the present embodiment, the light source 10, the polarizer 12, the stage S, the analyzer 14, and the detector 16 correspond to, for example, a spectral waveform acquiring unit.

The computer 20 is connected to the input unit 30 and the recording devices MR1 to MR3.

A recipe file in which processing steps of a later-described measuring method according to the embodiment is stored in the recording device MR1. The computer 20 reads the recipe file from the recording device MR1, and performs a later-described measurement.

The recording device MR2 is configured to store a library which is a collection of theoretical waveforms based on a simulation wherein spectral waveforms are acquired regarding all shape parameters previously estimated for the measurement target pattern TP. The recording device MR2 is also configured to store an actual spectral waveform chart of the pattern TP sent to the computer 20 from the detector 16.

The recording device MR3 is configured to temporarily store a measurement waveform in each measurement process described later and a model fitting result.

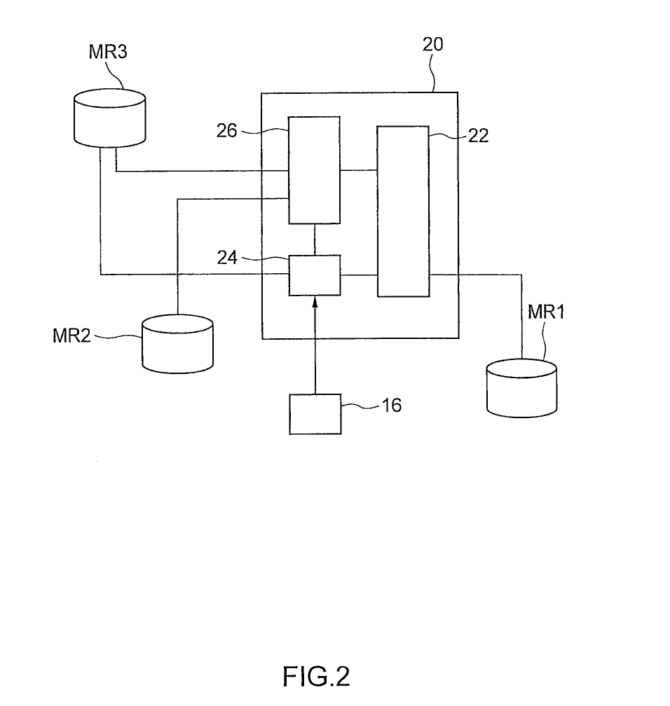

FIG. 2 is a block diagram showing a more detailed configuration of the computer 20 included in the measuring apparatus shown in FIG. 1.

As shown in FIG. 2, the computer 20 includes a control unit 22, a measurement waveform acquiring unit 24, and a model fitting unit 26.

The control unit 22 is connected to the measurement waveform acquiring unit 24 and the model fitting unit 26, and supplies control signals to these units.

The measurement waveform acquiring unit 24 is connected to the detector 16. The measurement waveform acquiring unit 24 receives an input of an actual spectral waveform of the measurement target pattern TP from the detector 16, measures its intensity to generate a measurement waveform, and sends the measurement waveform to the model fitting unit 26 and the recording device MR3.

When the acquisition of a measurement waveform in the final measurement process ends, the model fitting unit 26 uses the measurement waveform in each process stored in the recording device MR2 to perform model fitting by varying a shape parameter of the common structure and other shape parameters with a common shape parameter being linked. The model fitting unit 26 then extracts a shape parameter of a sectional shape model with the highest degree of correspondence, and outputs this shape parameter as a measurement result of the measurement target pattern.

### (B) Operation

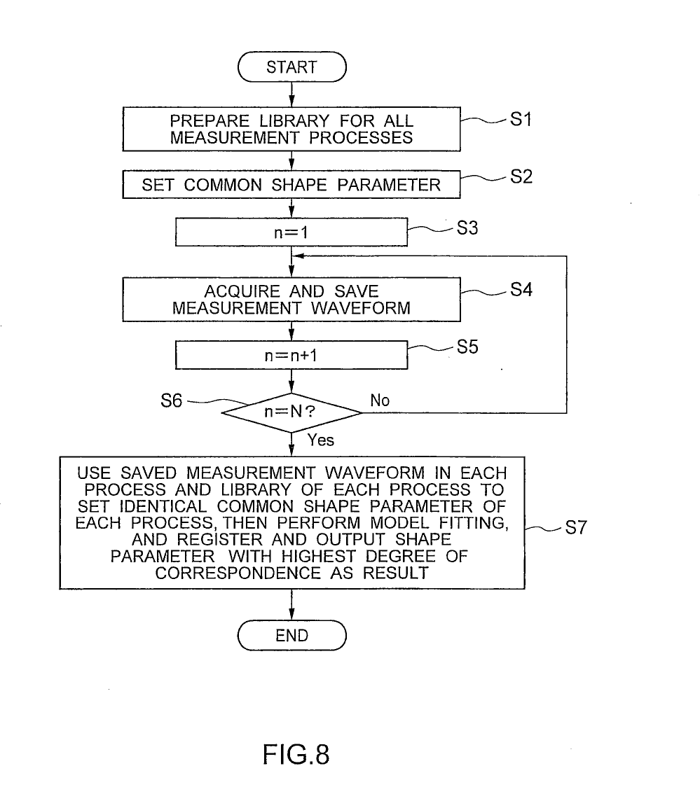

The operation of the measuring apparatus shown in FIG. 1 is described with reference to FIG. 3 to FIG. 6. Although first and second measurement processes are described below, the present invention is not at all limited to two measurement processes. It should be understood that the present invention is also applicable to three or more measurements (N>2), as will be described later with reference to a flowchart in FIG. 8.

FIG. 3 is a sectional view showing an example of the measurement target pattern TP in the first measurement process. A measurement target pattern TP1 shown in FIG. 3 is formed in the first measurement process, and includes a silicon oxide film IF1 formed on the semiconductor wafer W, and an interconnection pattern CF1 formed of polysilicon on the silicon oxide film IF1. In the present embodiment, the silicon oxide film IF1 corresponds to, for example, a first silicon oxide film.

FIG. 4 shows a measurement target pattern TP2 formed on the measurement target pattern TP1 shown in FIG. 3 by a second manufacturing process. The measurement target pattern TP2 includes a silicon oxide film IF2 formed on the silicon oxide film IF1 so as to cover the interconnection pattern CF1, and an interconnection pattern CF2 formed of an electric conductor on the silicon oxide film IF2. In the present embodiment, the silicon oxide film IF2 corresponds to, for example, a second silicon oxide film.

Thus, in the examples shown in FIG. 3 and FIG. 4, the measurement target pattern TP2 in FIG. 4 is fabricated on the directly inherited measurement target pattern TP1 in FIG. 3. Therefore, as indicated by a sign CS in FIG. 5, the same sectional shape as that of the measurement target pattern TP1 in FIG. 3 serves as a common structure of the measurement target patterns TP1 and TP2 in the first and second measurement processes. It should be understood that the measurement target patterns are not limited to the examples in FIG. 3 and FIG. 4 and have only to be patterns periodically arranged on a substrate. For example, a NAND flash memory, a ferroelectric random access memory (FRAM), a magnetoresistive random access memory (MRAM), and test patterns formed on a substrate are also included.

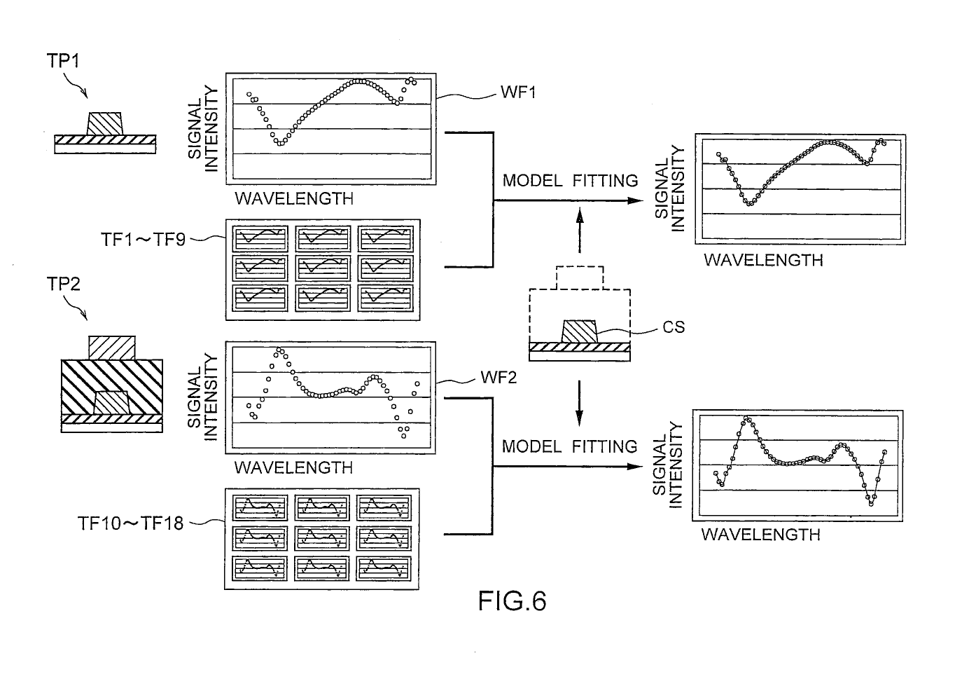

FIG. 6 is a diagram illustrating a measurement by the measuring apparatus shown in FIG. 1. First, in the first measurement process, light Li is applied to the measurement target pattern TP1 from the light source 10, and reflective diffracted light Lr is taken into the detector 16 via the analyzer 14 (see FIG. 1). Then, the measurement waveform acquiring unit 24 (see FIG. 2) processes a detection signal, and thereby actually acquires a spectral waveform WF1 of the pattern TP1. The acquired spectral waveform WF1 is stored in the recording device MR3.

In the second measurement process, light Li is then applied to the measurement target pattern TP2 from the light source 10, and reflective diffracted light Lr is taken into the detector 16 via the analyzer 14 (see FIG. 1). The measurement waveform acquiring unit 24 (see FIG. 2) then processes a detection signal, and thereby actually acquires a spectral waveform WF2 of the pattern TP2 as shown in FIG. 6.

The acquired spectral waveform WF2 is stored in the recording device MR3.

In the present embodiment, the measurement processes end with the second process. Therefore, the model fitting unit 26 makes a shape parameter for a common structure CS link to the measurement target pattern TP1 and the measurement target pattern TP2. The model fitting unit 26 makes the parameter of the common structure link to the spectral waveform WF1 acquired in the first measurement process and theoretical waveforms TF11 to TF19 and to the spectral waveform WF2 acquired in the second measurement process and theoretical waveforms TF21 to TF29. Thus, the model fitting unit 26 performs model fitting by varying the shape parameter of the common structure and other shape parameters. Waveforms are compared with the shape parameter for the common structure CS being linked and with the other shape parameters being varied. In this way, the highest degree of correspondence is searched for, and the current shape parameter of the sectional shape model in each process is registered in the recording device MR3 as a measurement result of the measurement target pattern TP2. The measurement result includes, for example, the thickness of the silicon oxide film IF2 and the thickness of the interconnection pattern CF2, and also includes, for example, the thickness of the silicon oxide film IF1, the thickness and the top face size and bottom face size of the interconnection pattern CF1, and the taper angle of a sidewall.

The model fitting unit 26 accesses the recording device MR3, and outputs the obtained shape parameter of the sectional shape model in each process as the final measurement result.

### (C) Referential Example

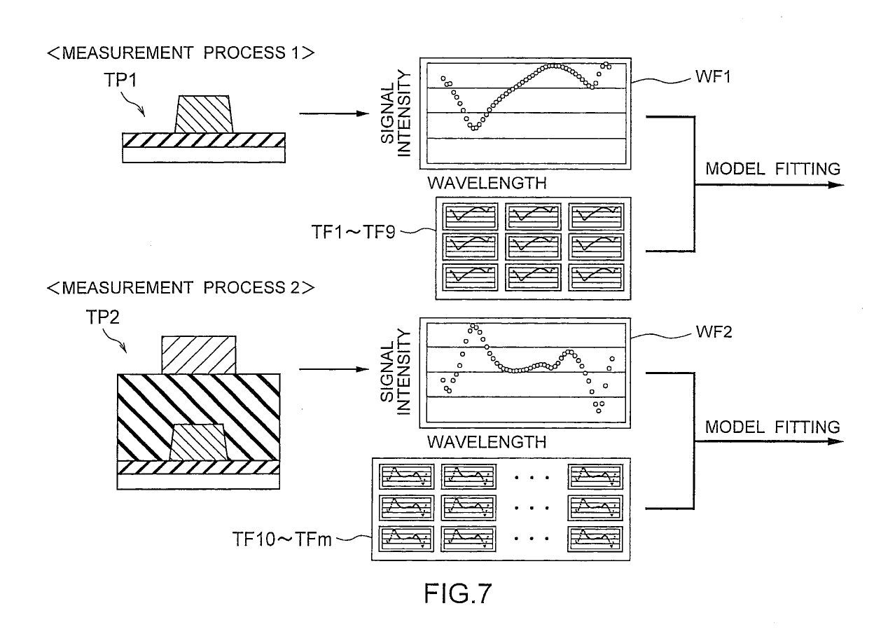

FIG. 7 is a diagram illustrating another measuring method as a referential example. As in the embodiment described above, the pattern TP1 shown in FIG. 3 is used as a measurement target pattern in the first measurement process, and the pattern TP2 in FIG. 4 is used as it is in the second measurement process.

The method of measuring the measurement target pattern TP1 is substantially the same as the measuring method according to the embodiment described above except for the setting of the shape parameter of the common structure and the registration of a measurement result, and is therefore not described in detail.

In this example, in the second measurement process, model matching is performed by varying all the shape parameters between the measurement waveform and the theoretical waveforms without using the measurement result in the first measurement process. Therefore, the theoretical waveforms to be compared with the measurement waveform are TF10 to TFm (m is a natural number equal to or more than 18) as schematically shown in FIG. 7 and the number of the theoretical waveforms is made greater than that of the theoretical waveforms in the measurement according to the embodiment described above. Accordingly, the measurement efficiency decreases.

Furthermore, according to the referential example in FIG. 7, an incorrect measurement result is more likely to be output. This is because there are some members which have different shapes and dimensions but which output similar spectral waveforms due to interaction between the shape parameters in the measuring method according to scatterometry. Such examples include the combination of amorphous silicon and polysilicon, the relation between dimensions and thickness, and the change of the taper angle. That is, as amorphous silicon and polysilicon show optically similar behavior, the boundary therebetween may not be recognizable. When the dimensions are reduced after the two manufacturing processes, the intensity of the spectral waveform may change as in the case where the thickness has decreased. Moreover, regarding the taper angle, a change of the taper angle in a member may appear as a horizontal dimensional change of this member.

In contrast to the referential example, according to the measuring method in the present embodiment, regarding the shape parameter of the common structure, the waveform in the earlier measurement process is used together, so that problems in the referential example are not caused.

### (2) One Embodiment of Measuring Method

The measuring method according to one embodiment is described with reference to the flowchart in FIG. 8.

First, a library is prepared for all the measurement processes (step S1). The number of measurement processes is not particularly limited, and first to N-th (N is a natural number equal to or more than 2) measurements are performed below.

A shape parameter of a common structure for a plurality of measurement processes is then set (step S2).

n=1 is then set (step S3), and the procedure moves to the first measurement process. Light is applied to the measurement target pattern to measure the intensity of a spectral waveform of reflected light. A measurement waveform is acquired and saved (step S4).

n=n+1 is then set (step S5).

The above-described processes from step S4 to step S5 are repeated until n=N, that is, until the final measurement process (step S6).

Furthermore, model fitting is performed between N theoretical waveforms and N measurement waveforms by varying the shape parameter of the common structure and other shape parameters with the shape parameter of the common structure being linked in each process. Degrees of correspondence between N theoretical waveforms and N measurement waveforms are calculated, and the shape parameter of the sectional shape model with the highest degree of correspondence is registered as a measurement result (step S7).

According to the measuring apparatus and the measuring method in the above-described at least one embodiment, model fitting is performed between a plurality of measurement waveforms and a plurality of theoretical waveforms by varying the shape parameter of a common structure and other shape parameters with the shape parameter of the common structure being linked. Therefore, computer resources can be specialized in the analysis of a signal from a structure specific to the subsequent measurement process, and the measurement accuracy can be improved.

### (3) Program and Non-Transitory Recording Medium

A series of procedures of the measurement described above may be incorporated in a program, and read into and executed by a control computer of the measuring apparatus which applies light to a measurement target pattern and detects a spectral waveform of reflected light to measure the measurement target pattern. This enables the measurement described above to be carried out by use of a general-purpose spectral waveform intensity measuring apparatus. A series of procedures of the measurement described above may be stored in a non-transitory recording medium such as a flexible disk or a CD-ROM as a program to be executed by the control computer of the spectral waveform intensity measuring apparatus, and read into and executed by the control computer.

The non-transitory recording medium is not limited to a portable medium such as a magnetic disk or an optical disk, and may be a fixed recording medium such as a hard disk drive or a memory. The program incorporating the series of procedures of the measurement described above may be distributed via a communication line (including wireless communication) such as the Internet. Moreover, the program incorporating the series of procedures of the measurement described above may be distributed in an encrypted, modulated or compressed state via a wired line or a wireless line such as the Internet or in a manner stored in a recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A measuring method comprising:
creating a sectional shape model for each measurement process of periodically arranged patterns formed by a plurality of manufacturing processes, predicting, by a simulation, a signal waveform which would be obtained when light is applied to the patterns, and thereby generating a plurality of theoretical waveforms;
setting a shape parameter of a common structure in the manufacturing processes;
applying light to a measurement target pattern obtained by actually creating the patterns in the respective measurement processes, measuring the intensity of a spectral waveform of reflected light, and thereby acquiring a plurality of measurement waveforms;
performing model fitting between the measurement waveforms and the theoretical waveforms by varying the shape parameter of the common structure and other shape parameters with the shape parameter of the common structure in the manufacturing processes being linked, and thereby calculating degrees of correspondence between the measurement waveforms and the theoretical waveforms; and
outputting, as a measurement result of the measurement target pattern, the shape parameter of the common structure and the other shape parameters in the sectional shape model with the desired degree of correspondence.

2. The measuring method of claim 1,
wherein the common structure comprises a first silicon oxide film on a substrate and a polysilicon pattern on the silicon oxide film.

3. The measuring method of claim 2,
wherein the polysilicon pattern comprises a taper angle.

4. The measurement method of claim 2,
wherein the measurement target pattern comprises a second silicon oxide film formed on the first silicon oxide film so as to cover the polysilicon pattern by a subsequent process of the manufacturing processes in which the common structure is formed.

5. The measurement method of claim 1,
wherein an optical system comprising a spectroscopic ellipsometer is used to apply light to the measurement target pattern and to measure the intensity of the spectral waveform of the reflected light.

6. The measurement method of claim 1,
wherein an optical system comprising a spectral reflectometer is used to apply light to the measurement target pattern and to measure the intensity of the spectral waveform of the reflected light.

7. A computer-readable non-transitory recording medium containing a program which causes a computer configured to control a measuring apparatus to execute a measurement, the measuring apparatus applying light to a measurement target pattern, detecting a spectral waveform of reflected light and measuring the measurement target pattern, the measurement comprising:
applying light to a measurement target pattern in each of a plurality of measurement steps, measuring the intensity of a spectral waveform of reflected light, and thereby acquiring a plurality of measurement waveforms, the measurement target pattern being obtained by actually forming periodically arranged patterns by a plurality of manufacturing processes;
performing model fitting between the measurement waveforms and a plurality of theoretical waveforms by varying the shape parameter of the common structure and other shape parameters with the shape parameter of the common structure in the manufacturing processes being linked, and calculating degrees of correspondence between the measurement waveforms and the theoretical waveforms, the theoretical waveforms being calculated from a sectional shape model by a simulation; and
outputting, as a measurement result of the measurement target pattern, the shape parameter of the common structure and the other shape parameters in the sectional shape model with the desired degree of correspondence.

8. The recording medium of claim 7,
wherein the common structure comprises a first silicon oxide film on a substrate and a polysilicon pattern on the silicon oxide film.

9. The recording medium of claim 8,
wherein the polysilicon pattern comprises a taper angle.

10. The recording medium of claim 8,
wherein the measurement target pattern comprises a second silicon oxide film formed on the first silicon oxide film so as to cover the polysilicon pattern by a subsequent process of a manufacturing process in which the common structure is formed.

11. The recording medium of claim 7,
wherein an optical system comprising a spectroscopic ellipsometer is used to apply light to the measurement target pattern and to measure the intensity of the spectral waveform of the reflected light.

12. The recording medium of claim 7,
wherein an optical system comprising a spectral reflectometer is used to apply light to the measurement target pattern and to measure the intensity of the spectral waveform of the reflected light.

13. A measuring apparatus comprising:
a spectral waveform acquiring unit configured to apply light to a measurement target pattern in each of a plurality of measurement steps, and measure the intensity of a spectral waveform of reflected light to generate a plurality of measurement waveforms, the measurement target pattern being obtained by actually forming periodically arranged patterns by a plurality of manufacturing processes;
a model fitting unit configured to perform model fitting between the measurement waveforms and a plurality of theoretical waveforms by varying the shape parameter of the common structure and other shape parameters with the shape parameter of the common structure in the manufacturing processes being linked, and calculating degrees of correspondence between the measurement waveforms and the theoretical waveforms, the theoretical waveforms being calculated from a sectional shape model by a simulation; and
an evaluating unit configured to output, as a measurement result of the measurement target pattern, the shape parameter of the common structure and the other shape parameters in the sectional shape model providing the desired degree of correspondence among the calculated degrees of correspondence.

14. The apparatus of claim 13, comprising an optical system of a spectroscopic ellipsometer.

15. The apparatus of claim 13, comprising an optical system comprising a spectral reflectometer.
